(19) United States
(12) Patent Application Publication
(10) Pub. No.: US 2026/0139147 A1
(43) Pub. Date: May 21, 2026

(54) PRINTABLE PASTE, PRINTED THIN FILM, MANUFACTURING METHOD, TEMPERATURE SENSOR, INRUSH CURRENT LIMITER, USE OF THE PRINTED THIN FILM IN AN ELECTRICAL COMPONENT

(71) Applicant: ATT ADVANCED THERMAL TECHNOLOGIES GMBH, Dobl-Zwaring (AT)

(72) Inventor: Manfred GRUBER, Stainz (AT)

(21) Appl. No.: 19/128,801

(22) PCT Filed: Nov. 8, 2023
(86) PCT No.: PCT/IB2023/061273

§ 371 Date: May 9, 2025

(30) Foreign Application Priority Data
Nov. 10, 2022 (DE) 10 2022 129 686.5

(51) Int. Cl. C09D 11/52; B41M 1/12; B41M 1/26; B41M 7/00; C09D 11/037; G01K 7/22; H01B 1/06

(52) U.S. Cl. CPC C09D 11/52; B41M 1/12; B41M 1/26; B41M 7/009; C09D 11/037; G01K 7/22; H01B 1/06

(57) ABSTRACT

A printable paste for producing an electrical component, including a printable, non-conductive coating, electrically conductive particles and ceramic NTC particles, wherein the electrically conductive particles and the ceramic NTC particles are homogeneously distributed in the printable, non-conductive coating. There is also provided a method for producing a printable paste, a thin film including the printable paste, a method for producing the thin film, and a temperature sensor and an inrush current limiter including the thin film having the printable paste.

The present invention relates to a printable paste according to patent claim 1, a method for producing the printable paste according to patent claim 15, a printed thin film comprising the printable paste according to patent claim 17, a method for producing the printed thin film according to patent claim 19, and a temperature sensor according to patent claim 20, an inrush current limiter according to patent claim 21, and the use of the printed thin film in an electrical component according to patent claim 22.

### TECHNOLOGICAL BACKGROUND

In the field of printed electronics, it is often necessary to integrate circuit elements with defined temperature dependency and accuracy, such as temperature sensors or inrush current limiters. This can be achieved by placing components on printed or etched circuits or by printing functional pastes. Assembled SMD (surface mounted device) components such as platinum resistors or ceramic NTCs (negative temperature coefficients) have the disadvantage that expensive conductive adhesives are often used when assembling printed electrodes. Etched electrodes involve reflow soldering processes that require high temperature stability of the base material. Furthermore, the geometric dimensions of the components in the integration area lead to a locally increased thickness. This can be a disadvantage, especially in applications where a flat design without protrusions is required. Furthermore, assembled components lead to a reduction in flexibility or a reduced mechanical strength. Due to the manufacturing tolerances in low-cost printing processes, the production of state-of-the-art printed temperature sensors often requires complex calibration in order to achieve a usable measurement accuracy. Furthermore, the calibration data must be transferred to the control or measuring device. In order to obtain accurate measurement results, a four-wire measurement may further be necessary.

EP 2 919 239 A1 is known from the prior art. It discloses an NTC sensor with a printable NTC paste based on silicon-carbon nanoparticles, which are surface-printed on gold electrodes. The silicon crystals are selected from doped silicon or non-doped silicon and the carbon particles are selected from the group consisting of carbon black, graphite flakes and graphene nanoplatelets.

The disadvantage of the known solution is that silicon is employed as the NTC material and that undoped and doped silicon is very energy-intensive to manufacture. The change in NTC resistance with temperature is determined by the silicon (intrinsic property) and can only be influenced to a limited extent by doping. Silicon forms an oxide layer (SiO2) in the presence of oxygen. This can have a thickness of up to 7 nm under natural environmental conditions. As a result, the contact resistance changes from particle to particle, which leads to reduced long-term stability.

WO 2018/164570 A1 is known from the prior art. Disclosed therein is a printed temperature sensor having an electrical circuit with a pair of electrodes. The sensor material, which is located between the electrodes, has semiconducting microparticles comprising an NTC material with a negative temperature coefficient (NTC), wherein the microparticles are mixed in a dielectric matrix. The dielectric matrix serves as a binder for printing the sensor material, wherein the microparticles contact each other to form an interconnected network through the dielectric matrix, wherein the interconnected network of microparticles acts as a conductive path with a negative temperature coefficient between the electrodes.

The disadvantage of these known solutions is that due to the very high solid content in the sensor material, the sensor material comprising the matrix and the microparticles becomes brittle and, as a result, the flexibility of the temperature sensor is reduced. Another disadvantage is that there is a strong dependence of the particle shape and particle size on conductivity in the NTC material, so that a volume proportion of more than 50% of NTC material is necessary.

US 2022/065707 A1 is known from the prior art. Various thin films for a temperature sensor are disclosed therein, wherein a thin film is created by means of a drop-on technique in at least one embodiment. This embodiment comprises a coating and conductive components. Conjugated polymer units doped with alkali metals are provided as conductive components.

The disadvantage of this known solution is that the resistance is significantly dominated by the resistance of gaps between the non-contacting conductive polymer units. This resistance is temperature-dependent and forms an NTC effect (electron hopping transport).

U.S. Pat. No. 3,408,311 A is known from the prior art. A temperature sensor made from a thin film is disclosed therein, the base being a powder comprising an inorganic binder.

The disadvantage of this solution is that such thin films have to be sintered and are therefore unusable for printed electronics.

### Presentation of the Invention

One object of the invention is to avoid at least one of the disadvantages of the prior art, and in particular to create an improved printable paste, which is preferably a functional paste for electrical components, with which a thin film is printable in the moist state, which thereby is electrically weakly conductive, and in the dry state is not brittle and becomes electrically more conductive, and thereby has a strongly exponential temperature dependence. Furthermore, improved manufacturing methods are to be created, as well as improved temperature sensors or improved inrush current limiters. In addition, the printed thin film comprising the printed paste should be usable in an electrical component.

This problem is solved by the features of the independent patent claims. Advantageous further embodiments are presented in the figures and in the dependent patent claims. A printable paste according to the invention for producing an electrical component comprises a printable, electrically non-conductive coating, electrically conductive particles and ceramic NTC particles, wherein the electrically conductive particles and the ceramic NTC particles are distributed homogenously in the printable, electrically non-conductive coating. In the homogenised, printable paste, the particles are evenly distributed and form an electrically weakly conductive network, whereby the printable paste is easy to process and can be printed reproducibly. For example, when homogenising the printable paste, a stirrer with a crossbeam stirrer is used, wherein a stirring speed of 500 revolutions per minute is used for 5 minutes. The quantity and shape of the conductive particles in the paste determine the resistance at, for example, 25° C. (R25) of a thin film. By addition of conductive particles to the printable coating and the ceramic NTC particles, the percolation in the paste is significantly improved, wherein the conductive particles improve the contacting of the ceramic NTC particles with each other. The resistance behaviour in the paste, or in the thin film that can be produced with it, is largely determined by the intrinsic properties of the NTC particles. The selection of the NTC particle materials in the paste makes it possible to adjust the resistance behaviour in the thin film, in particular its slope (B value) or to adjust the exponential temperature dependence of the thin film. Thus, the NTC resistance behaviour is adjustable independently of the resistance at, for example, 25° C. Due to sufficient percolation of the NTC particles in the dried thin film, the resistance is significantly dominated by the ceramic NTC particles and the resistance in the non-conductive coating between the particles only plays a subordinate role. The conductive particles used are in particular carbon, carbon black, nanotubes, silver, iron, steel, copper or comparable electrically conductive particles. Without conductive particles in the printable paste, at least 50% by volume or up to 70% by volume of ceramic NTC particles are required so that the desired percolation and thus a conductive thin film layer with strongly exponential temperature dependence is present in the dried state, for example in the form of a printed thin film. Thus, the improved printable paste can be produced with less energy consumption per kilogram of paste produced than comparable printable pastes from the prior art. This protects the environment as fewer CO2 emission is caused. In addition, costs, especially CO2 taxes, can be saved. The printable coating is electrically non-conductive, so that electrical contacting in the moist paste is excluded.

The printable paste has a viscosity of 15 Pa s to 100 Pa s in the flowable state, wherein the viscosity is determined using a Brookfield method. Brookfield viscosity usually refers to a viscosity measurement with a Brookfield viscometer. Thereby, a motor of the viscometer rotates a spindle at a specific speed (measured in rpm) or shear rate, and the viscometer measures the resistance to rotation and gives a viscosity value. The printable paste has a viscosity of preferably 20 Pa s to 60 Pa s in the flowing state, so that a suitable thin film between 10 micrometres and 250 micrometres can be produced easily and reproducibly, for example using a screen printing technique.

Preferably, the conductive particles are arranged in the printable coating such that the percolation threshold in the paste is undercut. Thus, a smaller quantity of ceramic NTC particles is required in the printable paste. The conductive particles improve the contacting of the ceramic NTC particles with each other. In the flowing or moist paste, the ceramic NTC particles are spaced apart from one another on average, wherein at least one conductive particle is essentially located between at least two ceramic NTC particles on average.

Percolation describes the formation of contiguous areas (clusters) between the ceramic NTC particles and the conductive particles in the printable paste or in the thin film produced with it. Thus, statistically seen, the present printable paste in its fluid or moist form does not exhibit any electrically conductive connection or exhibits only very weak electrical conductivity, since the printable coating is electrically non-conductive and there are hardly any continuous clusters between the ceramic NTC particles and the conductive particles. The resistance in the flowing or moist form is therefore of high resistance or infinite.

Preferably, the conductive particles are smaller than 100 micrometres. A paste with conductive particles with an average diameter of less than 100 micrometres can be printed easily and reproducibly. In particular, the resistance behaviour in a thin film produced with the printable paste is reproducibly adjustable.

Preferably, conductive particles smaller than 20 micrometres are present. Conductive particles with an average diameter of less than 20 micrometres diffuse better on average between the ceramic NTC particles, so that the percolation is improved and an improved strongly exponential temperature behaviour can be observed in the thin film produced with the printable paste.

Preferably, the printable paste has at least less than 50% by volume of conductive particles. By variation of the volume proportion of conductive particles, the conductivity in the printable paste can be finely adjusted. Thus, production fluctuations in the particle shape, size and conductivity of the ceramic NTC particles can be compensated for without changing the slope of the resistance behaviour. Thus, the shape or slope of the NTC curve can be adjusted independently of each other by selection of the NTC ceramic and the resistance at, for example, 25° C., by variation of the proportion of conductive particles.

Preferably, the ceramic NTC particles are powder particles so that the addition of the ceramic NTC particles to the printable paste is easily dosable.

Preferably, the ceramic NTC particles have a diameter of less than 100 micrometres so that the temperature behaviour of the ceramic NTC particles is adjustable. Preferably, the ceramic NTC particles have a diameter of between 10 micrometres and 60 micrometres so that printed thin films can be reproducibly produced.

Preferably, the conductive particles have a diameter of less than 50% of the diameter of the ceramic NTC particles. This makes it easier for the conductive particles to diffuse between the ceramic NTC particles when forming a thin film in order to exceed the percolation threshold. A thin film formed using the printable paste is sufficiently elastic so that it can be printed on film substrates and does not form cracks or craters in the thin film.

Preferably, the conductive particles have a diameter of less than 30% of the diameter of the ceramic NTC particles. This further improves the diffusion of the conductive particles and the thin film formed using the printable paste is not brittle.

Preferably, the conductive particles are rod-shaped or disc-shaped. As a result, even with a lower addition of conductive particles, percolation between the ceramic NTC particles is established in a stable and reliable manner. For example, a rod-shaped conductive particle is a nanotube and a disc-shaped conductive particle is a silver particle or carbon particle or graphite particle.

Preferably, the ceramic NTC particles comprise metal oxides, wherein, for example, metal oxides of the elements manganese, iron, nickel, cobalt or titanium can be employed. This allows an improved NTC behaviour to be adjusted in order to achieve the desired strongly exponential temperature behaviour. NTC materials, also known as thermistors, are temperature-dependent resistors that have a negative temperature coefficient as an essential property and conduct electrical current better at high temperatures than at low temperatures.

Preferably, the printable paste has at least less than 50% by volume of ceramic NTC particles. The lower solid content of the NTC material in the printable paste increases the flexibility and mechanical stability of an applied thin film that comprises the printable paste. A processed thin film (printed and dried) with the printable paste is very stable and insensitive to resistance drifts, i.e. the change in electrical resistance over time, even under high alternating thermal stresses. Thus, on average, the NTC particles form a maximally weakly conductive continuous network through the printable paste. Therefore, the printable paste is particularly easy to print or process.

Preferably, the printable paste has more than 10% by volume of ceramic NTC particles to ensure a sufficiently high percolation so that a highly exponential temperature behaviour is guaranteed.

Preferably, the printable, electrically non-conductive coating is solvent-based. Ceramic NTC particles can be sensitive to water, so that the use of a solvent-based, printable coating in the printable paste keeps the temperature behaviour of the printable paste reproducibly stable over many temperature cycles. Solvent-based, printable coatings comprise at least acrylic, or epoxy, or silicone, or polyurethane, or polyamide and other components. Any resistance drifts can be minimised. Alternatively, the printable coating is water-based, so that the printable paste can be produced in a more environmentally friendly way.

Preferably, the printable, non-conductive coating comprises at least one organic polymer. This is simply dried at low temperatures, less than 200° C. When drying, there is no fusion of the particles in the paste; instead, only the solvents are removed and any cross-linking reactions are activated. This allows thin films to be easily produced on film substrates without damaging the film, making them particularly suitable for printed electronics.

A method according to the invention for producing a printable paste, in particular a paste as described above, comprises the following steps:
a) Providing a Printable, Electrically Non-conductive Coating
b) Admixing electrically conductive particles to the printable, electrically non-conductive coating, wherein the admixture takes place below the percolation threshold
c) Admixing ceramic NTC particles to the printable, electrically non-conductive coating
d) Homogenising the electrically conductive particles and the NTC particles in the printable, electrically non-conductive coating.

This allows for an even distribution of particles in the printable paste, so that an electrically weakly conductive network is formed, wherein the printable paste is easy to process and reproducibly printable. By addition of conductive particles to the printable, electrically non-conductive coating and the ceramic NTC particles, the percolation in the paste is significantly improved, wherein the conductive particles improve the contacting of the ceramic NTC particles with each other. Without conductive particles in the printable paste, at least 50% by volume, preferably 70% by volume, of ceramic NTC particles are required so that a desired percolation and thus a conductive layer with a strong exponential temperature dependence can be achieved in the dried state, for example in the form of a thin film. Thus, the printable paste according to the invention can be produced using the method with less energy consumption per kilogramme of paste produced than comparable printable pastes from the prior art. This protects the environment as fewer CO2 emission is caused. In addition, costs, especially taxes, can be saved. In particular, the method is carried out at least in the order a) to d) indicated above, so that the adjustment of a target value for temperature dependence is improved without having to change the design of the printed thin film.

Preferably, at least less than 50% by volume of the ceramic NTC particles are admixed. The lower solid content of the NTC material in the printable paste increases the flexibility and mechanical stability in an applied thin film. A processed thin film layer (printed and dried) with the printable paste is very stable and insensitive to resistance drifts.

Preferably, more than 10% by volume of the ceramic NTC particles are admixed in order to ensure a sufficiently high percolation so that a highly exponential temperature behaviour can be guaranteed.

A printed thin film for an electrical component according to the invention comprises at least one printable paste as described above. The printed thin film can thereby be configured as a thin film layer in an electrical component. The lower solid content of the NTC material increases the flexibility and mechanical stability of the dried thin film. Breakage of the thin film under mechanical stress on the electrical component can be prevented as the thin film is not brittle in dry state. Furthermore, the electrical resistance of the dried thin film layer can thus be adjusted to a target value without having to change the design of the electrical component. Thereby, the shape of the strongly exponential temperature dependence of the resistance is retained (temperature difference −100° C.→change in resistance greater than a factor of 20). As a result, high manufacturing tolerances of the ohmic resistance only lead to a relatively small measurement inaccuracy. The dried printed thin film is comparable in its properties to a ceramic NTC. The resistance of the finished component can be influenced by the electrical properties of the ceramic NTC particles used or the conductive particles in the printable paste, the concentration of these, the printed thin film thickness, the printed surface and the electrode spacing and width of the printed electrodes. The thin film can be in particular less than 250 micrometres, in particular between 10 and 100 micrometres, thick without being brittle and breaking. Furthermore, the thin film can be produced with less energy consumption per kilogramme of paste produced than comparable thin films of printable pastes from the prior art.

Preferably, the printed thin film is produced using a screen printing process. Screen printing is primarily used, but offset, inkjet or pad printing processes can also be used. The screen printing used herein is carried out using a screen mesh, wherein the wet film thickness is roughly adjustable by varying the screen printing parameters (squeegee speed, squeegee angle, etc.). Thereby, it is preferable for the mesh size of the screen mesh to be larger than the particle size in order to prevent the screen mesh from clogging during printing. The max. grain size of the particles limits the selection of possible screen meshes that are used for the screen printing process. Thereby, the grain size of the particles must be smaller than the mesh size of the screen mesh or the characteristic size for the other previously mentioned printing processes.

Further disclosed is a method according to the invention for producing an electrically conductive thin film for an electrical component with a previously described printable paste, wherein the printable paste is printed onto a substrate, and at least the printable paste is dried at a temperature of less than 200° C. so that the paste becomes electrically conductive and in particular an electrical connection is formed between the electrically conductive particles and the ceramic NTC particles in order to form a strongly exponential temperature dependence in the electrically conductive paste. Thereby, an adjacent network with the electrically conductive particles and the ceramic NTC particles is formed without the mentioned particles fusing together. The drying temperature and time depend on the printable paste in the flowing state and the substrate thickness. However, it is to be ensured that the solvents have completely evaporated from the printed thin film. For support, the printed thin film can be additionally irradiated with infrared radiation. An applicable setting for a drying oven would be, for example, in a continuous oven at 140° C. and a dwell time of 10 minutes in the continuous oven (belt speed 1 m/min, oven length 10 m).

In particular, the printable paste is printed directly onto an at least sectionally electrically conductive substrate. Thus, an additional contacting of the printed thin film is unnecessary. Thereby, the substrate can have, for example, a silver layer as the first electrode.

The substrate can be a thin film so that the heat flows are only slightly distorted at high heat transfer coefficients. A processed thin film (printed and dried) with the printable paste is very stable and insensitive to resistance drifts.

A temperature sensor according to the invention comprises a first electrode and a second electrode, as well as at least one printed thin film as described above. Thus, a low-cost printed temperature sensor is created that can be easily integrated into an electrical component, such as a heating film for heating the surface of a vehicle interior. The printed temperature sensor is not touchable or not perceptible in the vehicle interior. The thin temperature sensor has only very small protrusions and a very high heat transfer coefficient. The temperature sensor is calibration-free. High manufacturing tolerances when producing the temperature sensor as a thin film with the printed paste only lead to small measurement inaccuracies. Due to the thin film, the thermal inertia is very low so that the temperature can be measured almost in real time. The resistance of the finished temperature sensor can be influenced not only by the electrical properties of the ceramic NTC or conductive particles used in the printable paste, the concentration of these, the thin film thickness, the printed surface and the electrode spacing and electrode width of the printed electrodes. The temperature sensor can be easily integrated into a flexible heating film. The printed temperature sensors can be produced in very thin thicknesses and can thus also be used in areas where local unevenness is undesirable. Furthermore, temperature sensors can be produced on the basis of thin foils, which have a high heat transfer coefficient and thus only slightly distort the heat flows.

An inrush current limiter according to the invention comprises at least one printed thin film as disclosed herein. Thus, an inexpensive printed inrush current limiter for electrical components has been created. The resistance of the finished inrush current limiter can be influenced by the electrical properties of the ceramic NTC particles used or the conductive particles in the printable paste, the concentration of these, the thin film

thickness and/or the printed surface. Theoretically, the inrush current limitation is maximum in the idle state (=no current), as this is an inherent property of an NTC material. The effect as an inrush current limiter decreases with increasing temperature. The configuration of the printed thin film with the ceramic NTC particles in the printable paste can influence the effect as an inrush current limiter. A larger (=higher-mass) thin film layer will realise the inrush current limitation with a less steeply falling gradient than a smaller (=lower-mass) thin film layer. Alternatively, the thickness of the substrate and/or the overall thickness or the printed thin film of the inrush current limiter can be varied such that a desired inrush current limitation is adjustable.

Furthermore, an inventive use of at least one printed thin film as disclosed herein in an electrical component is claimed. The thin film is not perceptible, adhesive-free and inexpensive. For example, the printed temperature sensor electrode can be produced simultaneously with a heating electrode, so that the production of a heating film including a temperature sensor is simplified and shortened in terms of time. The thin film can simply be applied to the temperature sensor electrode in a subsequent process step.

Further advantages, features and details of the invention will become apparent from the following description, in which embodiments of the invention are described with reference to the drawings.

The list of reference symbols, as well as the technical content of the patent claims and figures, forms part of the disclosure. The figures are described in a coherent and comprehensive manner. Identical reference numerals denote identical components, reference numerals with different indices indicate functionally identical or similar components. By means of the following figures, the invention is explained in more detail with reference to examples of embodiments.

Position specifications such as “top”, “bottom”, “right” or “left” refer to the corresponding representations and are not to be understood as limiting.

Although the invention is depicted and described in detail by means of the figures and the associated description, this depiction and this detailed description are to be understood as illustrative and exemplary and not as limiting the invention. It is understood that those skilled in the art may make changes and modifications without departing from the scope of the following claims. In particular, the invention also comprises embodiments with any combination of features mentioned or shown above for various aspects and/or embodiments.

The invention also comprises individual features in the figures, even if they are shown there in connection with other features and/or are not mentioned above. Furthermore, the term “comprise” and derivatives thereof do not exclude other elements or steps. Likewise, the indefinite article “a” or “an” and derivatives thereof do not exclude multiplicity. The functions of several features listed in the claims can be fulfilled by one unit. The terms “essentially”, “about”, “approximately” and the like in connection with a property or a value also define precisely the property or precisely the value, respectively. All reference numerals in the patent claims are not to be understood as limiting the scope of the patent claims.

### DESCRIPTION OF FIGURES

The figures are described in a coherent and comprehensive manner. Identical reference numerals denote identical components. It shows

FIG. 1: a strongly exponential temperature behaviour of a printable paste or a printed thin film comprising a printable paste,

FIG. 2: a printable paste according to the invention in a schematic view,

FIG. 3: another printable paste according to the invention in a schematic view,

FIG. 4a-4c: a simplified representation of a process for producing a printable paste according to FIG. 2 in a schematic view,

FIG. 5: a thin film according to the invention with a printable paste according to FIG. 2 in a schematic view, FIG. 6: an inrush current limiter according to the invention with a printed thin film according to FIG. 5 in a schematic view, and

FIG. 7: a temperature sensor according to the invention with a printed thin film according to FIG. 5 in a schematic view.

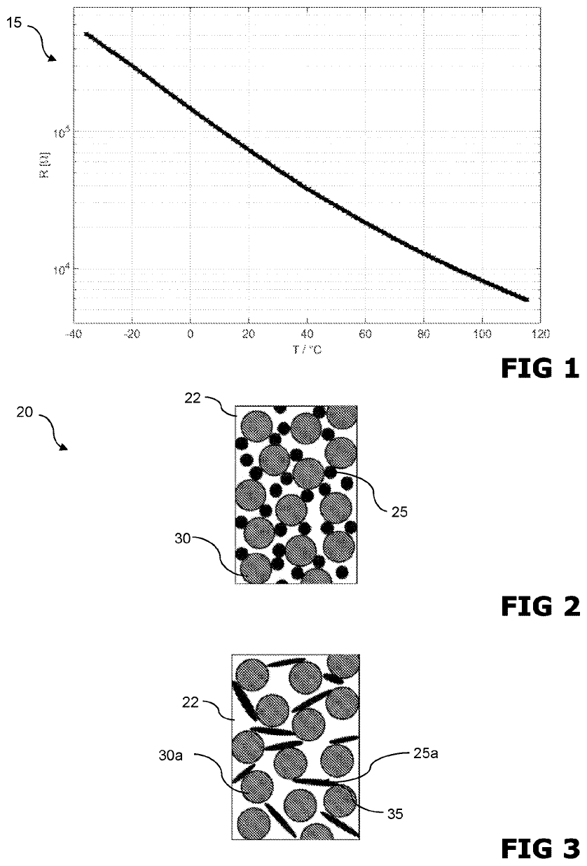

FIG. 1 shows a graph 15 with a strongly exponential temperature behaviour of a printable paste or a printed thin film with the printable paste, which are described below. Thereby, the temperature in ° C. is shown linearly on the abscissa and the electrical resistance in ohms is shown logarithmically on the ordinate.

FIG. 2 shows a first embodiment of the printable paste 20 for producing an electrical component comprising a solvent-based, printable, electrically non-conductive coating 22, electrically conductive particles 25 and ceramic NTC particles 30, wherein the electrically conductive particles 25 and the ceramic NTC particles 30 are homogeneously and uniformly distributed in the printable, electrically non-conductive coating 22. The particles 25, 30 form an electrically weakly conductive network 35 through the printable paste. By addition of the conductive particles 25 to the printable coating 22 and the ceramic NTC particles 30, the percolation in the paste 20 is significantly improved, wherein the conductive particles 25 improve the contacting of the ceramic NTC particles 30 with each other. The conductive particles 25 depicted here are carbon in powder form. The printable paste 20 has a viscosity of 20 Pa s to 60 Pa s in the flowable state. The conductive particles 25 in the printable coating 22 are arranged such that the percolation threshold in the printable paste 20 is undercut. In the flowing or moist paste 20, the ceramic NTC particles 30 are spaced apart from one another on average, wherein at least one conductive particle 25 is essentially located between at least two ceramic NTC particles 30 on average.

The conductive particles 25 are smaller than 100 micrometres, wherein disc-shaped conductive particles 25 are present which are smaller than 20 micrometres. Conductive particles 25 with an average diameter of less than 20 micrometres diffuse better on average between the ceramic NTC particles 30. Thereby, the printable paste 20 has less than 25% by volume of conductive particles 25 and less than 50% by volume of ceramic NTC particles 30.

The ceramic NTC particles 30 are powder particles and have a diameter of between 10 micrometres and 100 micrometres. The ceramic NTC particles 30 are metal oxides comprising nickel.

FIG. 3 shows another embodiment of the printable paste 20a for producing an electrical component as disclosed in FIG. 2, wherein the printable paste 20a has at least less than 50% by volume of conductive particles 25a and more than 10% of ceramic NTC particles 30a. The ceramic NTC particles 30a are metal oxides of manganese and the conductive particles 25a are rod-shaped nanotubes. The ceramic NTC particles 30a are powder particles and have a diameter of between 30 micrometres and 60 micrometres, wherein these diameters are also possible for other NTC materials.

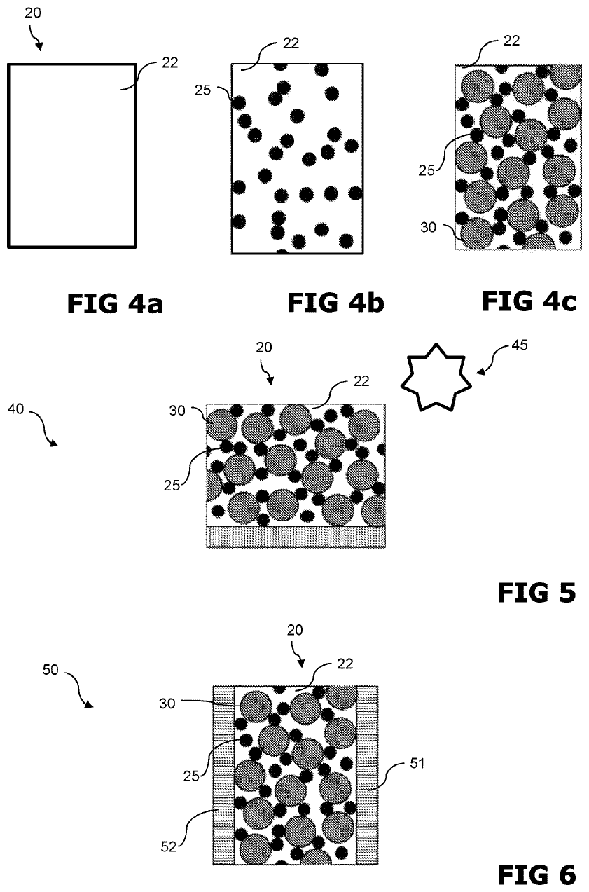

FIG. 4a to FIG. 4c show an embodiment of a method according to the invention for producing a printable paste 20 according to FIG. 2, comprising the following steps:
a) Providing the solvent-based, printable, electrically non-conductive coating 22
b) Admixing electrically conductive particles 25 to the printable, electrically non-conductive coating 22, wherein the admixture takes place below the percolation threshold
c) Admixing ceramic NTC particles 30 to the printable, electrically non-conductive coating 22
d) Homogenising the electrically conductive particles 25 and the NTC particles 30 in the printable, electrically non-conductive coating 22.

Thereby, at Least Less Than 50% by Volume of the Ceramic Ntc Particles 30 Are Admixed.

FIG. 5 shows a printed thin film 40 for an electrical component comprising at least one printable paste 20 according to FIG. 2, as previously described. The thin film 40 is printed on a flexible substrate, a thin foil 41. As a result, high manufacturing tolerances of the ohmic resistance only lead to a relatively small measurement inaccuracy. The dried and printed thin film 40 is comparable in its properties to a ceramic NTC. The resistance in the printed thin film 40 in a finished electrical component can be influenced not only by the electrical properties of the ceramic NTC particles 30 or the conductive particles 25 used in the printable paste 20, the concentration of these, the printed thin film thickness and the printed surface. The thin film 40 is less than 250 micrometres thick without being brittle or breaking and was produced using a screen printing process. When producing the thin film 40, the printable paste 20 is dried at a temperature of less than 200° C. so that the paste 20 becomes electrically conductive and an electrical connection is formed between the electrically conductive particles 25 and the ceramic NTC particles 30 in order to form a strongly exponential temperature dependence in the electrically conductive thin film 40. Thereby, an adjacent network is formed with the electrically conductive particles 25 and the ceramic NTC particles 30 without the mentioned particles 25, 30 fusing with each other. An applicable setting for an oven is, for example, in a continuous oven 45 at 140° C. and a dwell time of 10 minutes in the continuous oven 45 (belt speed 1 m/min, oven length 10 m).

FIG. 6 shows an embodiment of the inrush current limiter 50 according to the invention comprising at least one printed thin film 40, as shown in FIG. 5. The printed inrush current limiter for electrical components is arranged between two electrodes 51, 52. The resistance of the finished inrush current limiter is influenced by the electrical properties of the ceramic NTC particles 30 or the conductive particles 25 used in the thin film 40, the concentration of the particles 30, 25, the thickness of the thin film and/or the printed surface. Theoretically, the inrush current limitation is maximum in the idle state (=no current) at the time of switching on, as this is an inherent property of an NTC material. The effect as an inrush current limiter 50 decreases with increasing temperature. A larger (=higher-mass) thin film layer will realise the inrush current limitation with a less steeply falling gradient than a smaller (=lower-mass) thin film layer. Alternatively, the thickness of the substrate and/or the overall thickness of the inrush current limiter can be varied such that a desired inrush current limitation is adjustable. As a rule, smaller resistances are required than for a temperature sensor (thus either more surface printed with paste, smaller electrode spacing or more conductive paste).

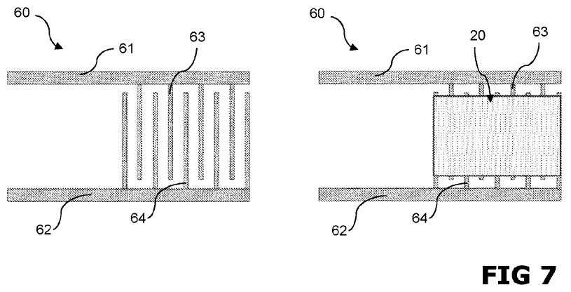

FIG. 7 shows an embodiment of the temperature sensor 60 according to the invention comprising a first electrode 61 and a second electrode 62, as well as at least one printed thin film 40, as previously described. The printed temperature sensor 60 is easy to integrate, to use in an electrical component, such as a heating film for heating the surface of a vehicle interior. A possible circuit design is depicted here. The printable paste 20 is applied to a previously generated electrode image (left) using screen printing. The electrodes 61, 62 are made of silver and are also printed on. The electrodes 61, 62 have webs 63, 64, which are spaced apart from each other and interlock on the thin film 41. The printable paste 20 is printed over the electrodes 61, 62 in the area of the webs 63, 64 and forms the previously described thin film (right) in dry state. Alternatively, the electrodes can also be arranged on the thin film 41 using an etching process.

### LIST OF REFERENCE SYMBOLS

15 graph
20 printable paste
22 printable, electrically non-conductive coating
25 conductive particles
30 ceramic NTC particles
20a printable paste
25a conductive particles
30a ceramic NTC particles
35 conductive network
40 thin film with 20
41 thin film
45 continuous oven
50 inrush current limiter
51 electrode
52 electrode
60 temperature sensor
61 electrode
62 electrode
63 bridge from 61
64 bridge from 62

1. A printable paste (20; 20a) for producing an electrical component comprising a printable, electrically non-conductive coating (22), electrically conductive particles (25; 25a) and ceramic NTC particles (30; 30a), wherein the electrically conductive particles (25; 25a) and the ceramic NTC particles (30; 30a) are homogeneously distributed in the printable, electrically non-conductive coating (22).

2. The paste according to claim 1, wherein the conductive particles (25; 25a) are arranged in the printable coating (22) so that the percolation threshold in the printable paste (20; 20a) is undercut.

3. The paste according to claim 1, wherein the conductive particles (25; 25a) are smaller than 100 micrometres, preferably conductive particles (25; 25a) are present which are smaller than 20 micrometres.

4. The paste according to claim 1, wherein the printable paste (25; 25a) has at least less than 50% by volume of conductive particles.

5. The paste according to claim 1, wherein the ceramic NTC particles (30; 30a) are powder particles.

6. The paste according to claim 1, wherein the ceramic NTC particles (30; 30a) have a diameter of less than 100 micrometres and preferably a diameter of between 10 micrometres and 60 micrometres.

7. The paste according to claim 1, wherein the conductive particles (25; 25a) have a diameter of less than 50% of the diameter of the ceramic NTC particles (30; 30a) and preferably have a diameter of less than 30% of the diameter of the ceramic NTC particles (30; 30a).

8. The paste according to claim 1, wherein the paste has a viscosity of 15 Pa s to 100 Pa s in the flowable state and preferably a viscosity of 20 Pa s to 60 Pa s.

9. The paste according to claim 1, wherein the conductive particles (25; 25a) are rod-shaped or disc-shaped.

10. The paste according to claim 1, wherein the ceramic NTC particles (30; 30a) comprise metal oxides.

11. The paste according to claim 1, wherein at least less than 50% by volume of ceramic NTC particles (30;
30a) are admixed and preferably more than 10% by volume of ceramic NTC particles (30; 30a) are admixed.

12. The paste according to claim 1, wherein at least more than 10% by volume of ceramic NTC particles (30; 30a) are admixed.

13. The paste according to claim 1, wherein the printable, non-conductive coating (22) is solvent-based.

14. The paste according to claim 1, wherein the printable, non-conductive coating (22) comprises at least one organic polymer.

15. A method for producing a printable paste, in particular a printable paste (20; 20a) according to claim 1, wherein the method comprises the following steps, in particular in the following order:
a) Providing a printable, electrically non-conductive coating (22)
b) Admixing electrically conductive particles (25; 25a) to the printable coating (22), wherein the admixture takes place below the percolation threshold
c) Admixing ceramic NTC particles (30; 30a) to the printable, electrically non-conductive coating (22)
d) Homogenising the electrically conductive particles (25; 25a) and the NTC particles (30; 30a) in the printable, electrically non-conductive coating (22).

16. The method according to claim 15, wherein at least less than 50% by volume of the ceramic NTC particles (30; 30a) are admixed.

17. A printed thin film (40) for an electrical component comprising at least one printable paste (20; 20a) according to claim 1.

18. The thin film according to claim 17, wherein the printed thin film is produced using a screen printing method.

19. The method for producing an electrically conductive thin film (40) for an electrical component with a printable paste (20; 20a) according to claim 1, wherein the printable paste (20; 20a) is printed onto a substrate, in particular is printed onto an at least sectionally electrically conductive substrate, and at least the printable paste (20; 20a) is dried at a temperature of less than 200° C., so that the printable paste (20; 20a) becomes electrically conductive and in particular an electrical connection is formed between the electrically conductive particles (25; 25a) and the ceramic NTC particles (30; 30a) in order to form a strongly exponential temperature dependence in the electrically conductive thin film (40).

20. A temperature sensor (60) comprising a first electrode (61) and a second electrode (62), and at least one printed thin film (40) according to claim 17.

21. An inrush current limiter (50) comprising at least one printed thin film (40) according to claim 17.

22. Use of at least one printed thin film (40) according to claim 17 in an electrical component.
